(19) United States
(12) Patent Application Publication
(10) Pub. No.: US 2015/0162640 A1
(43) Pub. Date: Jun. 11, 2015

(54) NONAQUEOUS ELECTROLYTE SECONDARY BATTERY AND METHOD OF MANUFACTURING NONAQUEOUS ELECTROLYTE SECONDARY BATTERY

(71) Applicants: Tetsuya Waseda, Okazaki-shi (JP); Takashi Tokunaga, Toyota-shi (JP)

(72) Inventors: Tetsuya Waseda, Okazaki-shi (JP); Takashi Tokunaga, Toyota-shi (JP)

(73) Assignee: TOYOTA JIDOSHA KABUSHIKI KAISHA, Toyota-shi, Aichi-ken (JP)

(21) Appl. No.: 14/411,599

(22) PCT Filed: Jun. 28, 2013
(86) PCT No.: PCT/IB2013/001576

§ 371 Date: Dec. 29, 2014

(30) Foreign Application Priority Data
Jun. 28, 2012 (JP) 2012-146150

(51) Int. Cl. H01M 10/04; H01M 10/0525

(52) U.S. Cl. CPC H01M 10/0431; H01M 10/0525; H01M 2220/20

(57) ABSTRACT

A nonaqueous electrolyte secondary battery includes a positive electrode, a negative electrode having, on a surface thereof, a negative electrode mixture layer containing a negative electrode active material, a thickening agent and a binder, and a separator. The positive electrode and the negative electrode are coiled together with the separator therebetween. The negative electrode active material has an average particle size of at least 5 μm and not more than 20 μm and has a fines content, defined as the cumulative frequency of the negative electrode active material having a particle size of 3 μm or less, of at least 10% and not more than 50%. The thickening agent has a 1.0% aqueous solution viscosity of at least 4,980 mPa·s. The negative electrode mixture layer is in an unpressed state.

### BACKGROUND OF THE INVENTION

1. Field of the Invention

The invention relates to a nonaqueous electrolyte secondary battery and to a method of manufacturing a nonaqueous electrolyte secondary battery.

2. Description of Related Art

Nonaqueous electrolyte secondary batteries, such as lithium ion secondary batteries, are a familiar technology. In recent years, the lithium ion secondary battery has been of growing importance as an on-board power supply for hybrid cars, electric cars and the like, and as a power supply installed in electrical products such as personal computers and handheld electronic devices.

A lithium ion secondary battery is typically constructed of, for example, a box-shaped battery case which is open on one side, an electrode assembly housed within the battery case, and a cover (lid) which is laser-welded to the battery case, thereby closing the opening in the battery case. The electrode assembly of the lithium ion secondary battery is typically constructed as a coiled electrode assembly which is obtained by arranging as successive layers and coiling a negative electrode, a separator and a positive electrode, and then deforming the coiled layers into a flattened shape.

For example, a method of manufacturing an electrode for a lithium ion secondary battery is disclosed in Japanese Patent Application Publication No. 2012-033364 (JP-2012-033364 A). JP-2012-033364 A describes a method of manufacturing a negative electrode by coating a negative electrode mixture paste onto a current-collecting foil and drying the paste, then pressing the dried paste to form it into a negative electrode mixture layer.

However, in a battery produced by such a battery manufacturing method, carrying out charge/discharge at a large current creates an imbalance in the salt concentration of the electrolyte solution at the interior of the coiled electrode assembly, as a result of which the internal resistance of the battery increases (which effect is referred to in the specification as “high-rate deterioration”). This phenomenon is thought to arise from high salt concentration electrolyte solution being at times forced out from within the coiled electrode assembly and at other times drawn into the interior. As a result, the salt concentration at the interior of the coiled electrode assembly falls, leading to a rise in the battery resistance.

Another concern is that when the negative electrode mixture layer is subjected to a pressing operation, the porosity of the layer decreases, worsening the ability of the electrolyte solution to impregnate the layer. This decline in the impregnating ability makes it more difficult for the electrolyte salt to diffuse to pores in the electrode, which presumably facilitates the imbalance in salt concentration that arises due to charge/discharge at large currents. If the negative electrode mixture is not pressed, this problem can be resolved. However, the peel strength of the electrode tends to decrease due to a worsening in the retention of the binder that binds together the active materials. As a result, undesirable effects such as peeling of the negative electrode mixture arise during slitting, and there is a possibility of contaminants generated by such peeling giving rise to microshorting at the battery interior, leading to a decline in production yield.

### SUMMARY OF THE INVENTION

The invention provides a nonaqueous electrolyte secondary battery which is capable of enhancing the high-rate deterioration characteristics while maintaining the peel strength of the negative electrode. The invention also provides a method of manufacturing such nonaqueous electrolyte secondary batteries.

A first aspect of the invention relates to a nonaqueous electrolyte secondary battery. The nonaqueous electrolyte secondary battery includes a positive electrode, a negative electrode having, on a surface thereof, a negative electrode mixture layer containing a negative electrode active material, a thickening agent and a binder, and a separator. The positive electrode and the negative electrode are coiled together with the separator therebetween. The negative electrode active material has an average particle size of at least 5 μm and not more than 20 μm, and has a fines content, defined as a cumulative frequency of the negative electrode material having a particle size of 3 μm or less, of at least 10% and not more than 50%. The thickening agent has a 1.0% aqueous solution viscosity of at least 4,980 mPa·s. The negative electrode mixture layer is in an unpressed state.

A second aspect of the invention relates to a method of manufacturing a nonaqueous electrolyte secondary battery. The method of manufacture includes: preparing a negative electrode paste by compounding a negative electrode active material having an average particle size of at least 5 μm and not more than 20 μm and having a fines content, defined as a cumulative frequency of the negative electrode active material having a particle size of 3 μm or less, of at least 10% and not more than 50%, a thickening agent having a 1.0% aqueous solution viscosity of at least 4,980 mPa·s, and a binder; forming a negative electrode mixture layer by applying the compounded negative electrode paste onto a current-collecting foil and drying the applied paste; and forming a negative electrode without pressing the negative electrode mixture layer.

According to the first and second aspects of the invention, the porosity of the negative electrode can be increased while maintaining the peel strength of this electrode, and the high-rate deterioration characteristics can be enhanced.

### BRIEF DESCRIPTION OF THE DRAWINGS

Features, advantages, and the technical and industrial significance of exemplary embodiments of the invention will be described below with reference to the accompanying drawings, in which like numerals denote like elements, and wherein:

FIG. 1 is a schematic diagram showing the overall structure of a lithium ion secondary battery according to an embodiment of the invention;

FIG. 2 is a schematic sectional view showing an electrode assembly according to an embodiment of the invention;

FIG. 3 is a graph showing the fines content;

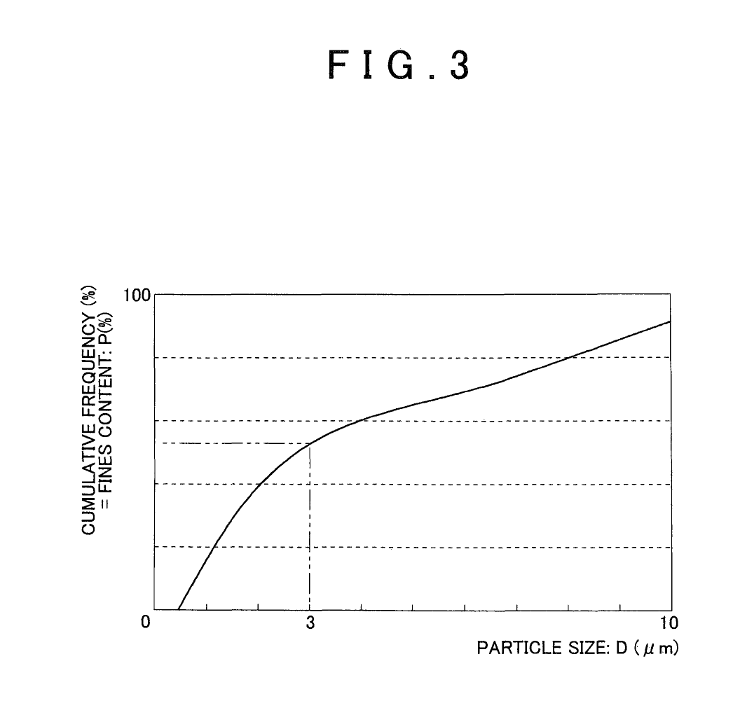

FIG. 4 is a graph showing the a porosity characteristic according to an embodiment of the invention;

FIG. 5 is a graph showing another porosity characteristic according to an embodiment of the invention; and

FIG. 6 is a flow chart showing the sequence of steps in the manufacture of a lithium ion secondary battery according to an embodiment of the invention.

### DETAILED DESCRIPTION OF EMBODIMENTS

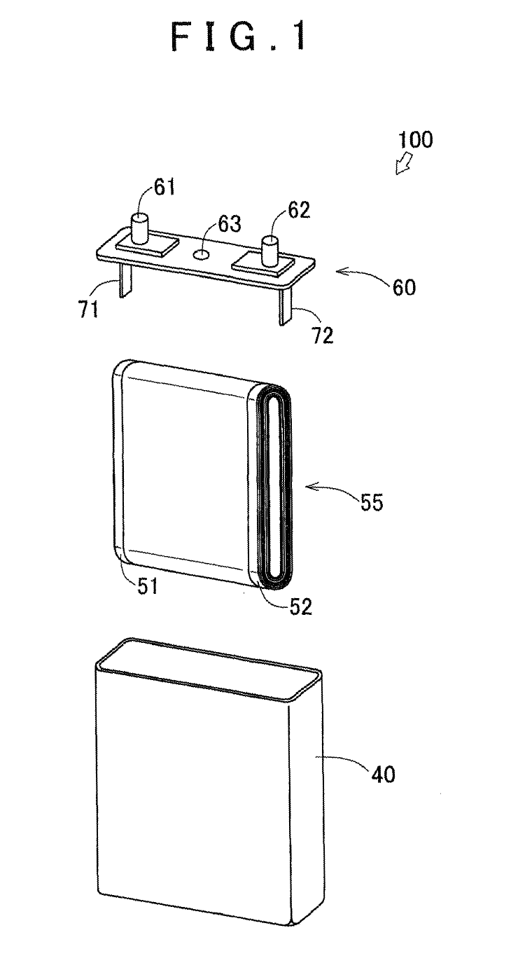

The structure of the lithium ion secondary battery 100 is described while referring to FIG. 1. In FIG. 1, for the sake of simplicity, the battery case 40, the coiled electrode assembly 55, and the lid 60 are separated and represented schematically.

The lithium ion secondary battery 100 is an embodiment of the nonaqueous electrolyte secondary battery of the invention. The lithium ion secondary battery 100 has a battery case 40, a coiled electrode assembly 55, and a lid 60.

The battery case 40 is formed as a substantially rectangular box, the top side of which is opened. The opened top side of the battery case 40 is closed by the lid 60. The coiled electrode assembly 55 is housed at the interior of the battery case 40.

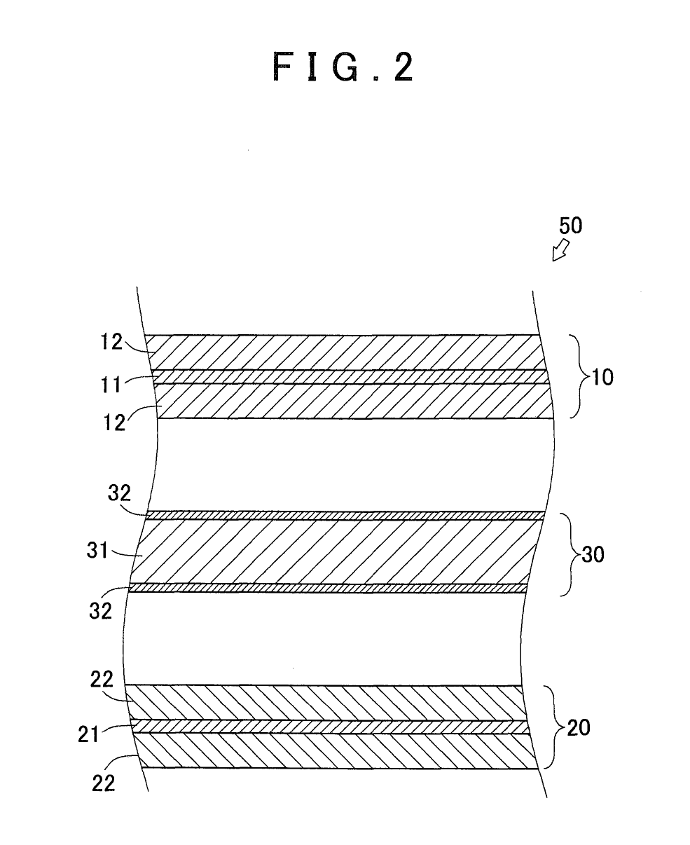

The coiled electrode assembly 55 is obtained by coiling an electrode assembly 50 (see FIG. 2) composed of a negative electrode 20, a positive electrode 10 and a separator 30 arranged as successive layers with the separator 30 disposed between the negative electrode 20 and the positive electrode 10, and then deforming the coiled layers into a flattened shape.

The coiled electrode assembly 55 is housed in the battery case 40 in such a way that the coiling axis direction of the coiled electrode assembly 55 is perpendicular to the direction in which the lid 60 closes the opening in the battery case 40.

At one end of the coiled electrode assembly 55 in the coiling axis direction, there is exposed a positive electrode current collector 51 (a portion where only the subsequently described current-collecting foil 11 is coiled). In addition, at the other end of the coiled electrode assembly 55 in the coiling axis direction, there is exposed a negative electrode current collector 52 (a portion where only the subsequently described current-collecting foil 21 is coiled).

The lid 60 closes the top side of the battery case 40. More specifically, the lid 60 is joined to the top side of the battery case 40 by laser welding, thereby closing the top side of the battery case 40. That is, in a lithium ion secondary battery 100, the opening in the battery case 40 is closed using laser welding to join the lid 60 to the opening in the battery case 40.

A positive electrode current-collecting terminal 61 and a negative electrode current-collecting terminal 62 are provided on the top side of the lid 60. A leg 71 that extends downward is formed on the positive electrode current-collecting terminal 61. Similarly, a leg 72 that extends downward is formed on the negative electrode current-collecting terminal 62.

An injection hole 63 is provided on the top side of the lid 60. The coiled electrode assembly 55 is housed within the battery case 40 in a state where the assembly 55 has been joined to the lid 60 having the positive electrode current-collecting terminal 61 and the negative electrode current-collecting terminal 62. After the lid 60 and the top side of the battery case 40 have been joined together by laser welding, the battery is completed by injecting an electrolyte solution through the injection hole 63.

The electrode assembly 50 is explained below while referring to FIG. 2. In FIG. 2, part of the electrode assembly 50 is shown schematically in cross-section.

The electrode assembly 50 is composed of a negative electrode 20, a positive electrode 10 and a separator 30 which are arranged as successive layers with the separator 30 disposed between the negative electrode 20 and the positive electrode 10.

[Positive Electrode Active Material]

The positive electrode 10 contains a positive electrode active material which inserts and extracts lithium. The positive electrode active material is typically a lithium-transition metal complex oxide having a layered crystal structure (typically a layered rock salt structure belonging to the hexagonal system), such as LiNiO₂, LiCoO₂ or LiNiCoMnO₂, portions of which may include added elements such as chromium, molybdenum, zirconium, magnesium, calcium, sodium, iron, zinc, silicon, tin and aluminum; a lithium-transition metal complex oxide having a spinel-type crystal structure (e.g., LiMn₂O₄, LiNiMn₂O₄); or a lithium-transition metal complex oxide having an olivine-type crystal structure (e.g., LiFePO₄).

[Positive Electrode Mixture]

In addition to a positive electrode active material, the positive electrode 10 may optionally include, for example, a conductive material and a binder. The conductive material may be a conductive substance such as carbon powder (e.g., graphite powder, and carbon blacks such as acetylene black, furnace black and ketjen black) or conductive carbon fibers. Such conductive substance may be included singly or as a mixture of two or more types.

The binder is exemplified by various types of polymer materials. For instance, in cases where a solvent composed primarily of water is used as the dispersion medium, preferred use may be made of a polymer material which dissolves or disperses in water. Illustrative examples of water-soluble or water-dispersible polymer materials include cellulose-based polymers such as carboxymethyl cellulose (CMC), polyvinyl alcohol (PVA), fluoroplastics such as polytetrafluoroethylene (PTFE), vinyl acetate polymers, and rubbers such as styrene-butadiene rubber (SBR). In cases where a solvent composed primarily of an organic solvent such as N-methyl-2-pyrrolidone (NMP) is used as the dispersion medium, a polymer material such as polyvinylidene fluoride (PVDF) or a polyalkylene oxide (e.g., polyethylene oxide (PEO)) may be used. The above binders may be used in combinations of two or more, and may also be used as thickening agents or other additives.

The proportions of the respective components (positive electrode active material, conductive material, binder, etc.) in the positive electrode mixture layer are selected from the standpoint of, for example, mixture layer retention on the positive electrode current collector and battery performance. Typically the amount of positive electrode active material is from about 75 wt % to about 95 wt %, the amount of conductive material is from about 3 wt % to about 18 wt %, and the amount of binder is from about 2 wt % to about 7 wt %.

[Method of Producing Positive Electrode]

First, a paste is prepared by mixing the positive electrode active material, conductive material, binder and the like together with a suitable solvent. Such mixing and paste preparation can be carried out using a mixing apparatus such as a planetary mixer, Homo Disper, Clearmix and Filmix.

The paste thus prepared is applied onto the positive electrode current collector with a coating device such as a slit coater, die coater, gravure coater or comma coater. The solvent is then evaporated off by drying, after which the applied coat of paste is pressed. By following these steps, a positive electrode composed of a positive electrode mixture layer formed on a positive electrode current collector is obtained.

In high-powered applications such as hybrid cars, the weight per unit surface area (mg/cm²) of the positive electrode mixture layer formed on the positive electrode current collector, from the standpoint not only of energy but also electron conductivity and lithium ion diffusibility within the mixture layer, is preferably set to from 6 mg/cm² to 20 mg/cm² per side of the positive electrode current collector. For similar reasons, the density of the positive electrode mixture layer is preferably set to from 1.7 mg/cm³ to 2.8 g/cm³.

An electrically conductive member composed of a metal having good conductivity is preferably used as the positive electrode current collector. Use may be made of aluminum or an alloy composed primarily of aluminum. The shape and thickness of the positive electrode current collector are not particularly limited. For example, the positive electrode current collector may be in the shape of a sheet, foil or mesh, and may have a thickness of from 10 μm to 30 μm.

[Negative Electrode Active Material]

The negative electrode 20 contains a negative electrode active material which inserts and extracts lithium. The negative electrode active material is exemplified by oxides such as lithium titanate, silicon materials and tin materials, whether as uncombined materials, alloys or chemical compounds, and also by composite materials which include these. Taking into overall account such considerations as cost, productivity, energy density and long-term reliability, use may be made of a carbonaceous active material composed primarily of graphite. Of these, in high-powered applications such as hybrid cars, it is more preferable to use a composite material which is made up of graphite-nucleated particles coated on the surface with amorphous carbon and is capable of enhancing lithium insertion and extraction properties. Carbon materials other than graphite, such as non-graphitizable amorphous carbon and graphitizable amorphous carbon, may also be admixed.

Of the above graphite, use may be made of, for example, spheroidized natural graphite. Spheroidizing treatment generally involves the application, by mechanical treatment, of stress in a direction parallel to the basal plane (AB plane) of the graphite crystals in, for example, flake graphite particles. When subjected to such treatment, the graphite spheroidizes as the basal planes of the graphite crystals of flake graphite take on a folded structure in a concentric or folded state. The target particle size can be achieved by carrying out crushing, grinding, screening and classification. Classification may be carried out by such methods as pneumatic classification, wet classification or gravity classification, with the use of a pneumatic classifier being preferred. The target particle size and distribution may be adjusted by controlling the volume and speed of air flow.

Alternatively, the graphite may be low-crystallinity carbon-coated natural graphite in the form of cores of spheroidized graphite which have been coated with an amorphous carbon material. Because low-crystallinity carbon-coated natural graphite includes spheroidized graphite as the cores, a high energy density can be obtained. It is found that the edges of spheroidized graphite (typically the edges of the hexagonal plane (basal plane) of the graphite) generally react with a nonaqueous electrolyte solution (typically, a nonaqueous solvent included in the electrolyte solution), causing a decline in battery capacity or increased resistance. By contrast, low-crystallinity carbon-coated natural graphite, because the surface is covered with an amorphous carbon material, suppresses to a relatively low level the reactivity with the nonaqueous electrolyte solution. Therefore, in lithium secondary batteries having such a low-crystallinity carbon-coated natural graphite as the negative electrode active material, an increase in irreversible capacity is suppressed, enabling a high durability to be exhibited.

Such a low-crystallinity carbon-coated natural graphite may be produced by, for example, an ordinary vapor-phase process (dry process) or a liquid-phase process (wet process). In this way, it is possible to advantageously furnish to part of the spheroidized graphite (typically, part of the outside surfaces) a carbon material having a low reactivity with the electrolyte solution. For instance, production may be carried out by mixing together, in a suitable solvent, spheroidized graphite as the cores and a carbonizable material such as pitch or tar as the precursor for the amorphous carbon, then depositing the carbon material on the surface of the spheroidized graphite and firing so as to sinter the carbon material that has been deposited on the surface. The proportions in which the spheroidized graphite and the carbon material are mixed may be suitably selected according to, for example, the type and properties of the carbon material used. The sintering temperature may be set to, for example, from 800° C. to 1300° C.

[Negative Electrode Mixture]

Aside from the negative electrode active material, the negative electrode 20 may also include additives such as a thickening agent and a binder. The thickening agent and the binder are exemplified by various types of polymer materials. For example, when a solvent composed primarily of water is used as the dispersion medium, preferred use may be made of a polymer material which dissolves or disperses in water. Examples of polymer materials which are water-soluble or water-dispersible include cellulose-based polymers such as CMC, PVA, fluoroplastics such as PTFE, vinyl acetate polymers, and rubbers such as SBR. In cases where a solvent composed primarily of an organic solvent such as NMP is used as the dispersion medium, a polymer material such as PVDF or a polyalkylene oxide (e.g., PEO) may be used. The above binders may be used in combinations of two or more, and may also be used as thickening agents or other additives.

The proportions of the respective components (negative electrode active material, conductive material, binder, etc.) in the negative electrode mixture layer are set from the standpoint of, for example, mixture layer retention on the positive electrode current collector and battery performance. Typically the amount of negative electrode active material is from about 90 wt % to about 99 wt %, and the amount of conductive material and binder is from about 1 wt % to about 10 wt %.

[Method of Producing Negative Electrode]

First, a paste is prepared by mixing the negative electrode active material, conductive material, binder and the like together with a suitable solvent. Such mixing and paste preparation may be carried out using a mixing apparatus such as a planetary mixer, Homo Disper, Clearmix and Filmix.

The paste thus prepared is applied onto the negative electrode current collector with a coating device such as a slit coater, die coater, gravure coater or comma coater. The solvent is then evaporated off by drying, after which the applied coat of paste is pressed. By following these steps, a negative electrode composed of a negative electrode mixture layer formed on a negative electrode current collector is obtained.

In high-powered applications such as hybrid cars, the weight per unit surface area (mg/cm²) of the negative electrode mixture layer formed on the negative electrode current collector, from the standpoint not only of energy but also electron conductivity and lithium ion diffusibility within the mixture layer, is preferably set to from 3 mg/cm² to 10 mg/cm² per side of the negative electrode current collector. For similar reasons, the density of the negative electrode mixture layer is preferably set to from 1.0 g/cm³ to 1.4 g/cm³.

An electrically conductive member composed of a metal having good conductivity is preferably used as the negative electrode current collector. Use may be made of copper or an alloy composed primarily of copper. The shape and thickness of the negative electrode current collector are not particularly limited. For example, the negative electrode current collector may be in the shape of a sheet, foil or mesh, and may have a thickness of from 5 μm to 20 μm.

[Separator]

The separator 30 has a mechanism which electrically insulates between the positive electrode mixture layer and the negative electrode mixture layer. Together with this, it also has a mechanism which permits electrolyte migration during normal use and blocks electrolyte migration when the battery interior reaches an elevated temperature (e.g., 130° C. or more) due to some abnormality. Examples of the separator include separators composed of porous resin layers. Preferred use can be made of a polyolefin resin such as polyethylene (PE) or polypropylene (PP) as the resin layer. A separator having a three-layer structure composed of PP, PE and PP stacked in this order is preferred.

The porous resin layers may be rendered porous by, for example, monoaxial orientation or biaxial orientation. Of these, monoaxial orientation results in a low thermal shrinkage in the width direction, and so the use of a monoaxially oriented layer as an element of the separator making up the above-described coiled electrode assembly is especially preferred.

The thickness of the separator is not particularly limited, and may be typically, for example, from about 10 μm to about 30 μm, and preferably from about 15 μm to about 25 μm. At a separator thickness within the above range, ions have an even better ability to pass through the separator, in addition to which rupture of the separator due to high-temperature shrinkage or melting can be minimized.

A heat-resistant layer is provided on at least one side of the resin layer so as to suppress shrinkage of the resin layer when the battery interior reaches an elevated temperature. Moreover, even should the resin layer rupture, shorting due to direct contact between the positive electrode and the negative electrode is suppressed. This heat-resistant layer includes as the primary component an inorganic filler, examples of which include inorganic oxides such as alumina, boehmite, silica, titania, zirconia, calcia and magnesia, inorganic nitrides, carbonates, sulfates; fluorides and covalent crystals. Of these, owing to their excellent heat resistance and cycle characteristics, alumina, boehmite, silica, titania, zirconia, calcia and magnesia are preferred, with boehmite and alumina being especially preferred.

The shape of the particles in the inorganic filler is not particularly limited, although flake-like particles are preferred for suppressing positive-negative electrode shorting when rupture of the resin membrane occurs. The average particle size of the inorganic filler is not particularly limited. However, from the standpoint of the flatness of the membrane surface, the input-output performance and ensuring functionality at high temperatures, it is suitable to set the average particle size to from 0.1 μm to 5 μm.

To obtain good retention of the heat-resistant layer on the separator resin layer, it is preferable for the heat-resistant layer to include additives such as a binder. The heat-resistant layer is generally formed by dispersing the inorganic filler and additives in a solvent to form a paste, then applying the paste onto the resin layer and drying. The dispersing solvent may be, for example, an aqueous solvent or an organic solvent and is not particularly limited. However, from the standpoint of cost and handleability, the use of an aqueous solvent is preferred. When a solvent composed primarily of aqueous ingredients is used, the additive may be a polymer which disperses or dissolves in an aqueous solvent. For example, use may be made of SBR, a polyolefin resin such as PE, a cellulose-based polymer such as CMC, PVA, or a polyalkylene oxide such as PEO. Use may also be made of an acrylic resin such as a homopolymer obtained by polymerizing a single type of monomer, such as acrylic acid, methacrylic acid, acrylamide, methacrylamide, 2-hydroxyethyl acrylate, 2-hydroxyethyl methacrylate, methyl methacrylate, 2-ethylhexyl acrylate or butyl acrylate. Alternatively, the additive may be a copolymer obtained by polymerizing two or more such monomers. In addition, it is also possible to use an additive obtained by mixing together two or more such homopolymers and copolymers.

The proportion of filler in the overall heat-resistant layer is not particularly limited, although from the standpoint of ensuring functionality at elevated temperatures, this proportion is typically at least 90 wt %, and preferably at least 95 wt %.

The heat-resistant layer may be formed by the following method. First, a paste is prepared by dispersing the above-described filler and additive in a dispersing solvent. Preparation of the paste may be carried out using a mixing apparatus such as a dispersion mill, Clearmix, Filmix, a ball mill, Homo Disper or an ultrasonic disperser. The resulting paste is coated onto the surface of the resin layer with a coating device such as a gravure coater, slit coater, die coater, comma coater or dip coater, then dried to form a heat-resistant layer. The temperature during drying is not more than the temperature at which shrinkage of the separator arises. For example, a temperature of not more than 110° C. is preferred.

When placing the coiled electrode assembly 55 in the battery case 40, the positive electrode current collector 51 in the coiled electrode assembly 55 is joined to the leg 71 on the positive electrode current-collecting terminal 61. Similarly, when placing the coiled electrode assembly 55 in the battery case 40, the negative electrode current collector 52 in the coiled electrode assembly 55 is joined to the leg 72 on the negative electrode current-collecting terminal 62. That is, the coiled electrode assembly 55 is housed within the battery case 40 in a state where it has been joined with the lid 60 having a positive electrode current-collecting terminal 61 and a negative electrode current-collecting terminal 62.

The electrode assembly 50 is described while referring to FIG. 2. In FIG. 2, a portion of the electrode assembly 50 is shown schematically in cross-section.

The electrode assembly 50 is composed of a negative electrode 20, a positive electrode 10 and a separator 30 which are arranged as successive layers, with the separator 30 disposed between the negative electrode 20 and the positive electrode 10.

The positive electrode 10 has a current-collecting foil 11 and a positive electrode mixture layer 12. A positive electrode mixture layer 12 is formed on both sides of the current-collecting foil 11. The positive electrode mixture layers 12 have been formed by, for example, mixing together a positive electrode active material (LJ_{1.14}NJ_{0.34}Co_{0.33}Mn_{0.33}O₂), a conductive material (AB) and a binder (PVDF) with a solvent (NMP) in given proportions so as to form a positive electrode paste, then applying the paste to the current-collecting foil 11 and drying.

The separator 30 has a base layer 31 and a heat resistance layer (HRL) 32 serving as the heat resistant layer. The HRL layer 32 is formed on either side of the base layer 31. The HRL layer 32 in this embodiment is formed of a porous inorganic filler.

The negative electrode 20 has a current-collecting foil 21 and a negative electrode mixture layer 22. The negative electrode mixture layer 22 has been formed by, for example, mixing together a negative electrode active material, a thickening agent and a binder in given proportions so as to prepare a negative electrode paste, then applying the paste to the current-collecting foil 21 and drying. The negative electrode active material of this embodiment has been formed by mixing and impregnating a given proportion of pitch into a low-crystallinity carbon-coated spheroidized natural graphite, then firing in an inert atmosphere. CMC having a 1.0% aqueous solution viscosity of at least 4,980 mPa·s is used as the thickening agent of this embodiment. In addition, SBR is used as the binder.

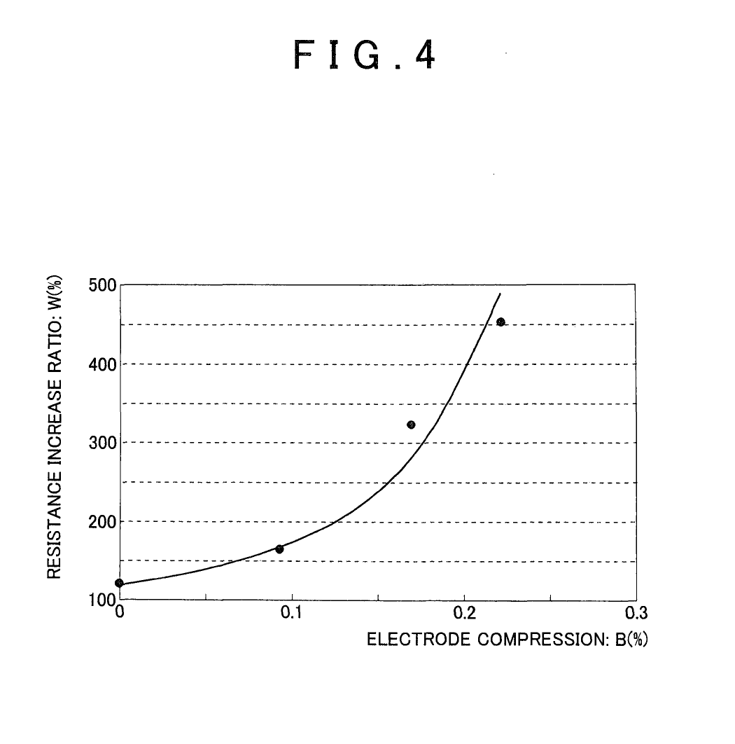

A characteristic of the porosity is explained in conjunction with FIG. 4. Letting the horizontal axis be the electrode compression B indicating the porosity of the negative electrode mixture layer 22, and letting the vertical axis be the resistance increase ratio W indicating the high-rate deterioration characteristic for a lithium ion secondary battery 100 (i.e., the deterioration performance in a state where a high current value flows through the battery), FIG. 4 shows the relationship between the porosity of the negative electrode mixture layer 22 and the high-rate deterioration characteristic.

Here, “electrode compression” refers to the compression ratio for the negative electrode mixture layer 22 after pressing, based on an arbitrary value of 100 for the thickness of the layer before pressing. Also, “resistance increase ratio W” refers to the ratio of increase in the charging resistance value after 1,000 cycles of charging under given high-rate conditions, based on an arbitrary value of 100 for the initial charging resistance value.

As shown in FIG. 4, there is a correlation between the electrode compression B for the negative electrode mixture layer 22 and the resistance increase ratio W for the lithium ion secondary battery 100, with a larger electrode compression B being accompanied by a larger resistance increase ratio W. This is because, as the electrode compression B becomes larger, the negative electrode active material on the surface of the negative electrode mixture layer 22 is crushed, penetration by the electrolyte solution decreases and an imbalance in salt concentration arises.

Here, when the criterion (condition for satisfying a standard) for the resistance increase ratio W that exhibits a high-rate deterioration characteristic in the lithium ion secondary battery 100 was set to 100%, the electrode compression was most preferably 0% (unpressed), at which the resistance increase ratio W value was smallest.

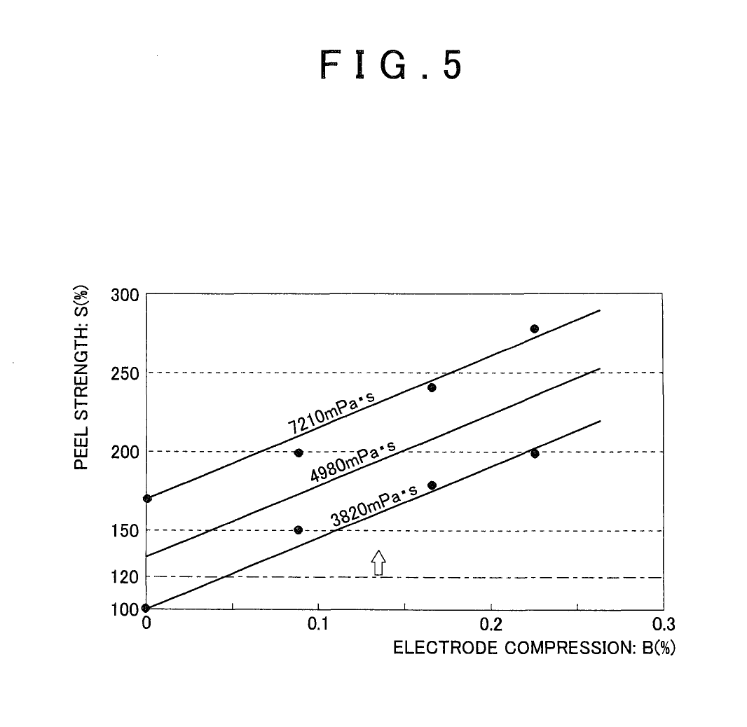

Another characteristic of the porosity is explained while referring to FIG. 5. Letting the horizontal axis be the electrode compression B indicating the porosity of the negative electrode mixture layer 22, and letting the vertical axis be the peel strength S of the negative electrode mixture layer 22 from the current-collecting foil 21 in the negative electrode 20, which peel strength S indicates the safety of the negative electrode mixture layer 22, FIG. 5 shows the relationship between the porosity and the safety of the negative electrode mixture layer 22.

Here, “peel strength S” refers to the magnitude of the peel strength, based on an arbitrary value of 100% for the peel strength from the current-collecting foil 21 of a negative electrode mixture layer 22 which contains a thickening agent having a 1.0% aqueous solution viscosity of 3,820 mPa·s and has an electrode compression B of 0%.

In addition, FIG. 5 shows the relationship between the peel strength S from the current-collecting foil 21 of the negative electrode mixture layer 22 containing a thickening agent having a 1.0% aqueous solution viscosity of 3,820 mPa·s and the electrode compression B. It also shows the relationship between the peel strength S from the current-collecting foil 21 of the negative electrode mixture layer 22 containing a thickening agent having a 1.0% aqueous solution viscosity of 4,980 mPa·s and the electrode compression B. It additionally shows the relationship between the peel strength S from the current-collecting foil 21 of the negative electrode mixture layer 22 containing a thickening agent having a 1.0% aqueous solution viscosity of 7,210 mPa·s and the electrode compression B.

As shown in FIG. 5, there is a correlation between the electrode compression B and the peel strength S of the negative electrode mixture layer 22, with the peel strength S becoming larger at a larger electrode compression B. That is, taking into account only the high-rate deterioration characteristic, in cases where the negative electrode mixture layer 22 is not pressed, there is a possibility of the peel strength S becoming smaller and of a decrease in safety occurring.

However, as shown in FIG. 5, there is a correlation between the 1.0% aqueous solution viscosity of the thickening agent and the peel strength S of the negative electrode mixture layer 22, with the peel strength S becoming larger as the 1.0% aqueous solution viscosity of the thickening agent rises.

Here, when the criterion for the peel strength S was set to 120% or more, in an unpressed state, the peel strength S of the negative electrode mixture layer 22 containing a thickening agent having a 1.0% aqueous solution viscosity of 3,820 mPa·s was smaller than 120%. The peel strengths S of negative electrode mixture layers 22 containing a thickening agent (CMC) having a 1.0% aqueous solution viscosity of 4,980 mPa·s and a thickening agent having a 1.0% aqueous solution viscosity of 7,210 mPa·s were 120% or more. Hence, the 1.0% aqueous solution viscosity of the thickening agent is preferably at least 4,980 mPa·s.

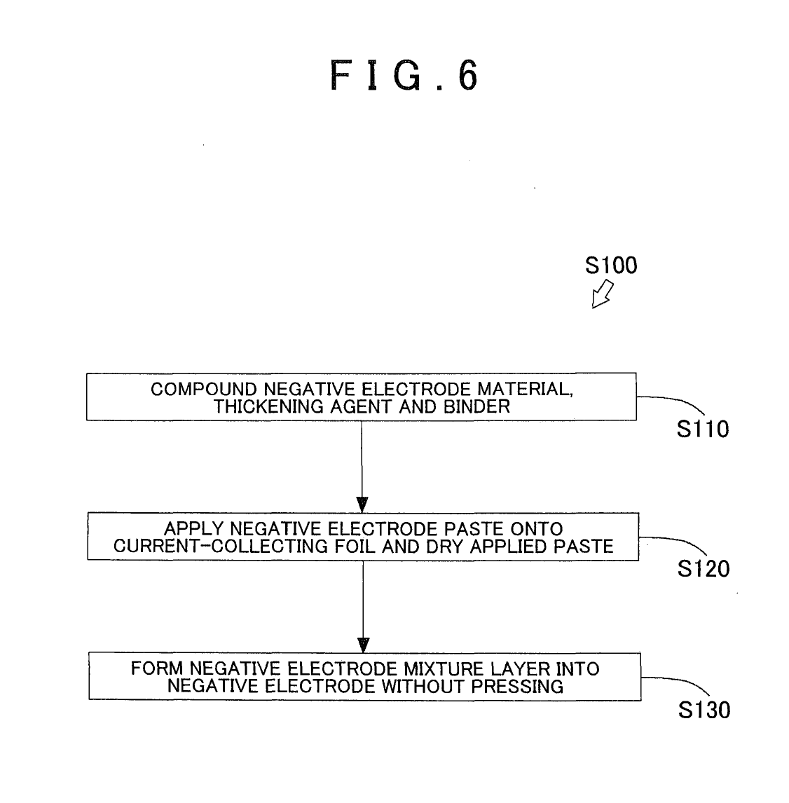

The lithium ion secondary battery manufacturing step S100 is explained while referring to FIG. 6. In FIG. 6, the sequence of operations in the lithium ion secondary battery manufacturing step S100 is shown as a flow chart.

The lithium ion secondary battery manufacturing step S100 is an embodiment of the inventive method of manufacturing a nonaqueous electrolyte secondary battery. S100 is the step of manufacturing a lithium ion secondary battery 100.

In step S110, a negative electrode paste is prepared by compounding the following: a negative electrode active material which has an average particle size of at least 5 μm and not more than 20 μm and has a fines content P, defined as the cumulative frequency of the negative electrode material having a particle size of 3 μm or less, of at least 10% and not more than 50%, a thickening agent having a 1.0% aqueous solution viscosity of at least 4,980 mPa·s, and a binder.

In step S120, the negative electrode paste compounded in step S110 is coated onto the current-collecting foil 21 and dried, forming a negative electrode mixture layer 22. In step S130, the negative electrode mixture layer 22 is formed into a negative electrode 20 without being pressed.

The advantageous effects of the lithium ion secondary battery 100 and the lithium ion secondary battery manufacturing operation S100 are explained. The lithium ion secondary battery 100 enables the porosity of the negative electrode 20 to be increased while the peel strength of the negative electrode 20 is maintained, thereby making it possible to enhance the high-rate deterioration characteristic.

That is, because there is a correlation between the electrode compression B and the resistance increase ratio W, it is possible to set the electrode compression B, which is targeted at a given criterion for the resistance increase ratio W serving as an indicator of the high-rate deterioration characteristic, to 0%, and thereby enhance the high-rate deterioration characteristic.

Also, the peel strength S decreases as a result of setting the electrode compression B to 0%. However, a correlation exists between the 1.0% aqueous solution viscosity of the thickening agent and the peel strength S of the negative electrode mixture layer 22, thus defining the 1.0% aqueous solution viscosity of the thickening agent that satisfies a given criterion for the peel strength S serving as an indicator of safety, and ensuring safety of the negative electrode 20.

TABLE 1

| | | EX | EX | CE | CE | CE | CE |
|---|---|---|---|---|---|---|---|
| Negative | % | 0 | 0 | 0 | 0.08 | 0.17 | 0.23 |
| electrode | | | | | | | |
| active | | | | | | | |
| material | | | | | | | |
| (compression) | | | | | | | |
| Density | g/cm³ | 0.90 | 0.90 | 0.90 | 1.07 | 1.24 | 1.41 |
| CMC | mPa · s | 7210 | 4980 | 3820 | 7210 | 7210 | 7210 |
| viscosity | | | | | | | |
| Copper foil | μm | 2.5 | 2.5 | 2.5 | 13 | 18 | 20 |
| surface | | | | | | | |
| roughness | | | | | | | |
| Peel strength | % | 168 | 140 | 100 | 198 | 240 | 278 |
| target, 120% | | | | | | | |
| (3,820 mPa · s; | | | | | | | |
| letting 0 | | | | | | | |
| compression | | | | | | | |
| be 100%) | | | | | | | |
| High-rate test | % | 113 | 112 | 110 | 152 | 318 | 458 |
| (resistance | | | | | | | |
| increase ratio | | | | | | | |
| target, 100%) | | | | | | | |
| Rating | | ∘ | ∘ | Δ | x | x | x |

1. A nonaqueous electrolyte secondary battery comprising:
a positive electrode;
a negative electrode having, on a surface thereof, a negative electrode mixture layer containing a negative electrode active material, a thickening agent and a binder; and
a separator,
wherein the positive electrode and the negative electrode are coiled together with the separator therebetween,
the negative electrode active material has an average particle size of at least 5 μm and not more than 20 μm and has a fines content, defined as a cumulative frequency of the negative electrode active material having a particle size of 3 μm or less, of at least 10% and not more than 50%,
the thickening agent has a 1.0% aqueous solution viscosity of at least 4,980 mPa·s, and
the negative electrode mixture layer is in an unpressed state.

2. A method of manufacturing a nonaqueous electrolyte secondary battery, comprising:
preparing a negative electrode paste by compounding a negative electrode active material having an average particle size of at least 5 μm and not more than 20 μm and having a fines content, defined as a cumulative frequency of the negative electrode active material having a particle size of 3 μm or less, of at least 10% and not more than 50%, a thickening agent having a 1.0% aqueous solution viscosity of at least 4,980 mPa·s, and a binder;
forming a negative electrode mixture layer by applying the compounded negative electrode paste onto a current-collecting foil and drying the applied paste; and
forming a negative electrode without pressing the negative electrode mixture layer.
